(19) United States
(12) Patent Application Publication
(10) Pub. No.: US 2011/0136545 A1
(43) Pub. Date: Jun. 9, 2011

(54) ELECTRONIC DEIVCE AND DISPLAYING METHOD THEREOF

(75) Inventor: LUNG DAI, Tu-Cheng (TW)

(73) Assignee: HON HAI PRECISION INDUSTRY CO., LTD., Tu-Cheng (TW)

(21) Appl. No.: 12/955,936

(22) Filed: Nov. 30, 2010

(30) Foreign Application Priority Data
Dec. 8, 2009 (CN) 200910311055.3

(51) Int. Cl. H04W 88/02

(52) U.S. Cl. 455/566

(57) ABSTRACT

A displaying method for an electronic device. The electronic device includes a display, a plurality function modules being to call functions, a storage unit for storing particular functions and display the time associated with each of the particular functions. The displaying method includes determining whether a called function belongs to the particular functions; turning on the display if the called function belongs to the particular functions and beginning to count a time; determining whether the counted time reaches the display time associated with the called function; and turning off the display if the counted time reaches the associated display time.

### BACKGROUND

1. Technical Field

The present disclosure relates to electronic devices, and particularly to an electronic device having a display and a displaying method for the electronic device.

2. Description of Related Art

Electronic devices such as mobile phones, personal digital assistants, generally use batteries as power supplies. In order to extend the charge life of the battery, power saving modes may be employed in the device. For example, backlights, which consume much power, are designed to turn off automatically after a time of inactivity.

However, if the user is reading a long message or document, this will be interpreted as a period of inactivity and a power saving mode will be entered, which is troublesome to the user.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block function diagram of an electronic device with a plurality of function modules in accordance with an exemplary embodiment.

FIG. 2 is a table for showing a relationship between the function modules and display time of the electronic device in FIG. 1.

FIG. 3 is a flow chart of a displaying method in accordance with an exemplary embodiment.

### DETAILED DESCRIPTION

The present discloser provides an electronic device with a displaying method, a display of the electronic can be turned off only when the displaying is not needed. Thus, it does not make trouble for a user.

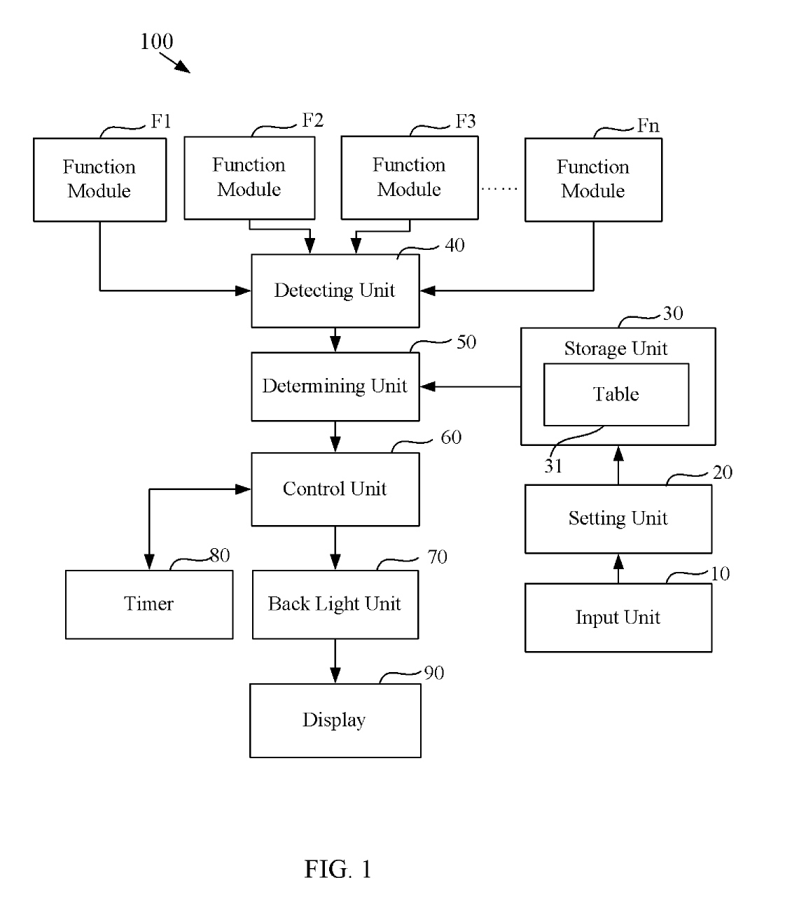

Referring to FIG. 1, a function diagram of an electronic device 100 is shown. The electronic device 100 may be a mobile phone or PDA for example. The electronic device 100 includes a display 90. In this embodiment, the display 90 is a liquid crystal display (LCD) display. In other embodiments, the display 90 may instead be, for example, a light emitting diode (LED) display or a plasma display panel (PDP) display.

The electronic device 100 further includes an input unit 10, a setting unit 20, a storage unit 30, a detecting unit 40, a determining unit 50, a control unit 60, a back light unit 70, a timer 80, and a plurality of function modules F1·Fn. Each of the function modules F1·Fn may be a program stored in the electronic device 100, and executed by the electronic device 100 to perform a corresponding function. For example, the function module F1 may perform a video recording function, the function module F2 may perform an MP3 function, the function module F3 may perform a call function, and the function module Fn performs a reading function and so on.

The back light unit 70 is configured to generate back light for the display 90.

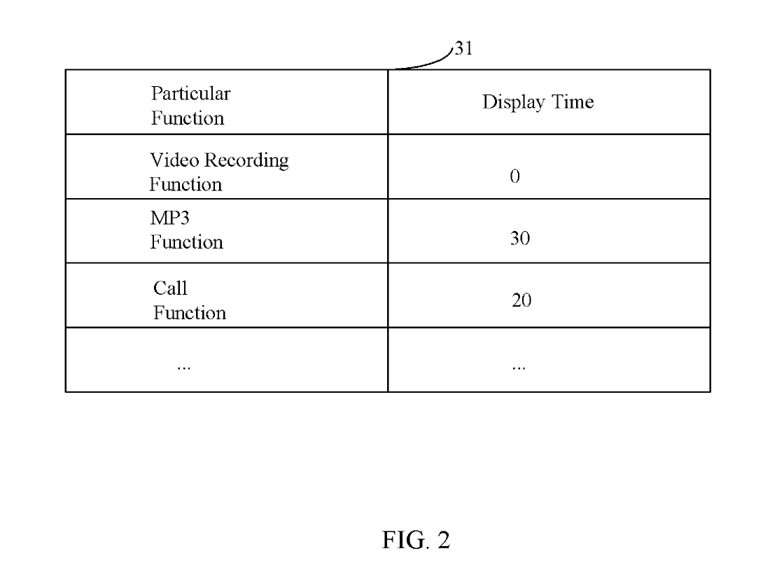

Some or all of the functions F1·Fn may be designated as particular functions that are associated with a display time limit. In this embodiment a table 31 in the storage unit 30 lists the particular functions. Referring to table 31 in FIG. 2, the storage unit 30 is configured to store a list of particular functions of the electronic device 100 and display time associated with each particular function. In this embodiment, when the display time has elapsed for a called function the device 100 will enter a power saving mode. In this embodiment the backlight turns off when the power saving mode is entered. An example of the relationships between the listed particular functions and display times are shown in table 31. The display time indicates how long from a time a function is called and no activity takes place, such as a user input, the backlight of the display 90 remains on. In this embodiment, not all functions of the electronic device 100 which require the use of the display 90 need to be listed in the table 31 and associated with a display time. When any of those functions not listed in the table 31 are called there will be no automatic entering of the power saving mode. For example, for functions involved in displaying documents or messages the backlight would remain on indefinitely until the function was closed. The table 31 can be set by the manufacturer and in some embodiments modified by a user, and default display times can be set by the manufacturer and modified by the user. In other embodiments, all functions that make use of the display 90 can be listed in the table 31 and the user can select display time for each function or select always on for a function meaning power saving mode will not be entered when that function is in use. Thus, the electronic device 100 can be more user-friendly while still being able to enter power saving mode when appropriate.

The input unit 10 is configured to generate commands in response to user operations. The input unit 10 may be buttons or a touch panel.

The setting unit 20 is configured to modify the table 31 in response to the commands.

For example, the display time listed in the table 31 can be modify by the setting unit 20.

The detecting unit 40 is configured to detect states of the function modules F1-Fn, and when it is detected that one of the function modules F1-Fn has been called, the detecting unit 40 generates a corresponding operating signal indicating that function has been called.

The determining unit 50 is configured to determine whether the called function is listed in the table 31 to determine whether the called function belongs to the particular functions. The determining unit 50 is further configured to generate a first control signal when it is determined that the called function is listed in the table 31, or to generate a second control signal when it is determined the called function is not listed in table 31.

The control unit 60 is configured to obtain the display time corresponding to the called function from the storage unit 30 if the called function is listed in the table 31, and control the backlight unit 70 to generate backlight for the display 90 in response to the first control signal, at the same time, the control unit 60 is configured to control the timer 80 to begin to count time. The control unit 60 is further configured to determine whether the counted time reaches the obtained display time, and control the backlight unit 70 to stop generating backlight if the counted time reaches the obtained display time. The control unit 60 is further configured to detect whether the electronic device 100 receives a user command during the time the timer 80 is counting, and resetting the timer 80 to start counting the time from the beginning if the electronic device 100 receives the user command. The control unit 60 is further configured to detect whether the electronic device 100 receives a user command after the display 90 is turned off, and control the backlight unit 70 to turn on and the timer 80 to start counting time again if the electronic device 100 receives the user command.

The control unit 60 is further configured to control the backlight unit 70 to continuously generate backlight for the display 100 during a time a called function that is not listed in the table 31 is operating, in response to the second control signal.

In another embodiment, if the display 90 is not the LCD display, the backlight unit 70 can be omitted, and the control unit 60 can directly control power supplied to the display 90 to turn on/off the display 90.

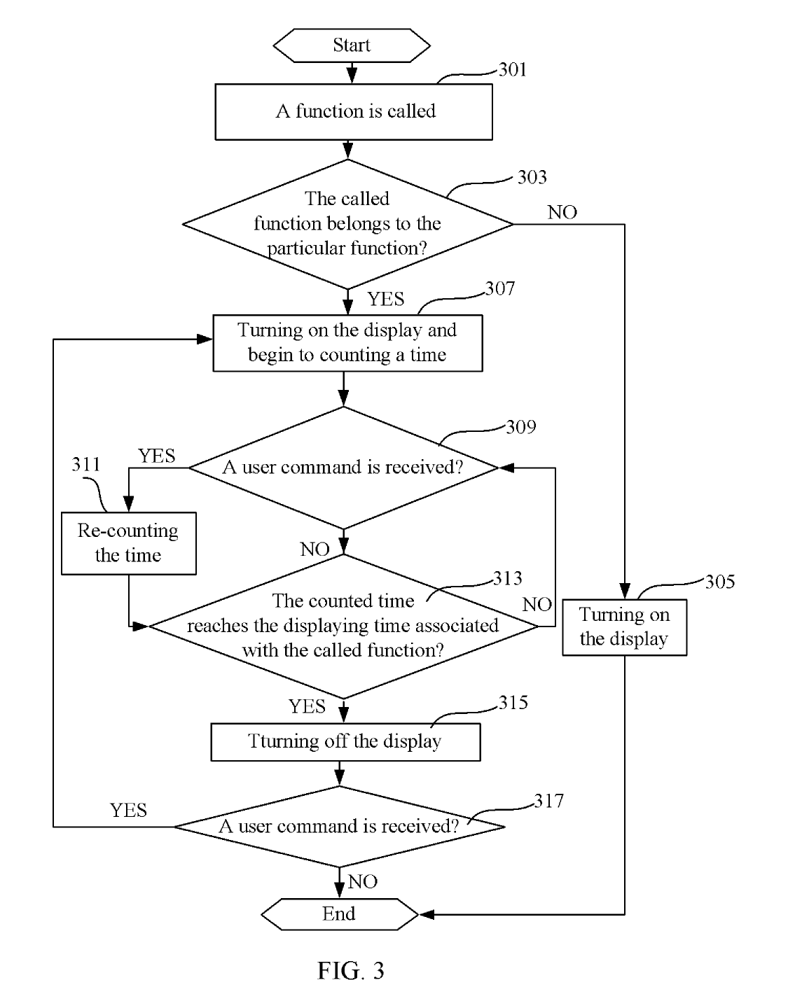

Referring to FIG. 3, a displaying method for an electronic device is shown. The electronic device includes a display, and a plurality function modules and a storage unit. The plurality function modules are selectively called by the electronic device to call corresponding functions, and Some or all of the functions may be designated as particular functions that are associated with a display time limit. The storage unit lists the particular functions and a display time associated with each of the particular functions as a table. The displaying method includes the following steps:

In step 301, a function is called.

In step 303, detecting whether the called function belongs to the particular functions.

In step 305, turning on the display if the called function does not belongs to the particular.

In step 307, turning on the display and begin to counting a time, if the called function belongs to a pre-set particular function.

In step 309, detecting whether a user command is received.

In step 311, re-counting the time, and then jumping to the step 309 if it is detected that the user command is received.

In step 313, determining whether the counted time reaches the display time associated with the called function, and then jumping to the step 309, if it is detected that no user command is received.

In step 315, turning off the display if the counted time reaches the display time. For example the display is an LCD display, the display is turned off by turning on back light of the LCD display.

In step 317, detecting whether a user command is received and then jumping to step 307 if it is detected that the user command is received.

As describe above, the electronic device 100 and the displaying method set the particular functions that electronic device 100 will be turn off display 90 when the display time has elapsed for the particular function being called without any user' operations on the electronic device 100, and the display 90 will be always on when the functions which don't belong to the particular functions are in used. Thus, the electronic device 100 will not only saves the electricity energy but is also user friendly.

It is to be understood, however, that even though information and advantages of the present embodiments have been set forth in the foregoing description, together with details of functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electronic device comprising:
a display to display information;
a plurality of function modules being requested to call functions;
a storage unit to store particular functions and display time associated with the particular functions;
a detecting unit to detect which function module executes a call function;
a determining unit to determine whether the called function belongs to the particular functions; and
a control unit to obtain the displaying time corresponding to the called function from the storage unit if the called function is determined to belong to the particular functions, and control the display to turn on, and control the display to turn off if a time of the display turning on reaches the obtained display time.

2. The electronic device of claim 1, wherein the control unit control the display to turn on if it is determined that the called function does not belong to the particular function unit.

3. The electronic device of claim 1, further comprising a timer, the control unit further control the timer to count a time the display is turned on, and control the display to turn off if the counted time reaches the obtained display time.

4. The electronic device of claim 3, wherein the control unit is further configured to detect whether a user command is received by the electronic device during the time the timer counts, and control the timer to reset and start counting the time from the beginning if the user command is received.

5. The electronic device of claim 3, wherein the control unit is further configured to detect whether a user command is received by the electronic device after the display is turned off, and control the display to turn on and the timer to start counting time again if the user command is received.

6. The electronic device of claim 1, wherein the display is a liquid crystal display (LCD), the control unit controls back light to be generated or not to be generated for the LCD display to turn on/off to turn on/of the LCD display.

7. A displaying method of an electronic device, the electronic device comprising a display, a plurality of function modules being to call functions, a storage unit for storing particular functions and display the time associated with each of the particular functions, the displaying method comprising:
determining whether a called function belongs to the particular functions;
turning on the display and beginning to count a time if it is determined that the called function belongs to the particular functions;
determining whether the counted time reaches the display time associated with the called function;
turning off the display if the counted time reaches the associated display time.

8. The displaying method of claim 7, wherein before the step of determining whether the counted time reaches the display time associated with the called function, the displaying method further comprising:
detecting whether a user command is received by the electronic device;
re-counting the time if the user command is received by the electronic device.

9. The displaying method of claim 7, wherein after the step of turning off the display, the displaying method further comprising:
detecting whether a user command is received by the electronic device;
turning on the display and re-counting the time if the user command is received by the electronic device.

10. The displaying method of claim 7, wherein the display time associated with each particular functions is different.

11. The displaying method of claim 7, wherein if the display is an LCD display, turning on/off the display is performed by turning on/off back light for the LCD display.
